(19) United States
(12) Patent Application Publication
(10) Pub. No.: US 2016/0244699 A1
(43) Pub. Date: Aug. 25, 2016

(54) Clay Granule

(71) Applicant: DANISCO US INC., Palo Alto, CA (US)

(72) Inventors: Rajdeep S. Dhaliwal, Oakland, CA (US); Douglas A. Dale, Pacifica, CA (US); Scott D. Power, Woodside, CA (US)

(73) Assignee: Danisco US Inc., Palo Alto, CA (US)

(21) Appl. No.: 15/027,565

(22) PCT Filed: Oct. 14, 2014
(86) PCT No.: PCT/US2014/060360

§ 371 Date: Apr. 6, 2016

Related U.S. Application Data
(60) Provisional application No. 61/891,338, filed on Oct. 15, 2013.

(51) Int. Cl. C11D 3/386; C11D 3/04; B08B 3/08; C11D 1/66; C11D 17/00; A47L 15/00; C11D 3/12; C11D 3/37

(52) U.S. Cl. CPC C11D 3/38609; C11D 3/126; C11D 3/046; C11D 3/3753; C11D 3/1213; C11D 1/66; C11D 17/0039; A47L 15/0007; B08B 3/08; A47L 2601/18

(57) ABSTRACT

The present teachings provide an improved granule comprising a clay layer. The granules can be used in a variety of contexts, including automatic dish washing applications. Methods of making and using are also provided.

### CROSS REFERENCE TO RELATED APPLICATIONS

This application claims benefit of priority from U.S. Provisional Patent Application Ser. No. 61/891,338, filed on 15 Oct. 2013, the contents of which is incorporated herein by reference in their entirety.

### FIELD OF THE INVENTION

This disclosure is directed towards improved compositions for layered granules containing clay and active agents, and methods of making and using.

### BACKGROUND OF THE INVENTION

The use of active agents, such as enzymes, in detergents, foods, and animal feed has become a common practice. There is an ongoing need in the detergent industry for stable enzyme granules that maintain activity after being subjected to harsh conditions.

Approaches to avoid the problem of irreversibly inactivating enzymes or reducing the activity of the enzyme in industrial processes include identifying new sources of an enzyme (e.g. the identification of a known enzyme in an extreme thermophile microorganism) or identifying means to stabilize known enzymes. Klibanov, 1983, (Stabilization of Enzymes against Thermal Inactivation, Advances in Applied Microbiology, volume 29, page 1-28) discloses that there are three basic means for stabilizing enzymes: (1) immobilization, (2) chemical modification and (3) inclusion of additives. While previous formulation approaches have made some progress in this area (see for example WO9854980, WO9739116, WO2007044968), and EP1996028) the present teachings make an additional advance in overcoming some of these problems by use of an improved granule structure.

In the context of the detergent industry, the removal of phosphate from auto dish detergents (ADW) results in an environment where enzyme stability is more challenging. The removal of phosphate causes the water activity (Aw) of the detergent base to increase. The percarbonate bleaching system typically used in this context has a lower stability in this environment, resulting in creation of oxidative species during storage. The present teachings provide a granule for addressing stability problems that can result from this environment.

For ease of reference we have described elements of the present teachings under one or more headings. It is to be noted that the teachings under each of the headings also apply to the teachings under the other headings. For example, each of the stated embodiments and aspects concerning the use of the present teachings is equally an embodiment or aspect concerning the method of the present teachings or the composition of the present teachings. Likewise, each of the stated embodiments and aspects concerning the method or use of the present teachings is equally an embodiment or aspect concerning the composition of the present teachings.

All patents, patent applications, publications, documents, and articles cited herein are all incorporated herein by reference in their entireties.

### SUMMARY OF THE INVENTION

The present teachings provide a granule comprising; a core with an active agent enzyme matrix; and, a clay layer comprising no less than 25% clay. In some embodiments, the active agent comprises SEQ ID NO:1. In some embodiments, the clay layer comprises bentonite, for example, 28-33% bentonite. In some embodiments, the core comprises a sodium sulfate seed, the active agent is SEQ ID NO: 1 or a protein 95% identical to it, the clay layer comprises 30% bentonite, and one additional layer surrounds the clay layer.

Additional methods, uses, and compositions are also provided.

### BRIEF DESCRIPTION OF THE FIGURES

FIG. 1 depicts an illustrative clay granule according to the present teachings.

FIG. 2 depicts illustrative data according to the present teachings.

### DETAILED DESCRIPTION

The practice of the present teachings will employ, unless otherwise indicated, conventional techniques of molecular biology (including recombinant techniques), microbiology, cell biology, biochemistry, and animal feed pelleting, which are within the skill of the art. Such techniques are explained fully in the literature, for example, Molecular Cloning: A Laboratory Manual, second edition (Sambrook et al., 1989); Oligonucleotide Synthesis (M. J. Gait, ed., 1984; Current Protocols in Molecular Biology (F. M. Ausubel et al., eds., 1994); PCR: The Polymerase Chain Reaction (Mullis et al., eds., 1994); Gene Transfer and Expression: A Laboratory Manual (Kriegler, 1990), and Fairfield, D. 1994. Chapter 10, Pelleting Cost Center. In Feed Manufacturing Technology IV. (McEllhiney, editor), American Feed Industry Association, Arlington, Va., pp. 110-139.

Unless defined otherwise herein, all technical and scientific terms used herein have the same meaning as commonly understood by one of ordinary skill in the art to which the present teachings belong. Singleton, et al., Dictionary of Microbiology and Molecular Biology, second ed., John Wiley and Sons, New York (1994), and Hale & Markham, The Harper Collins Dictionary of Biology, Harper Perennial, NY (1991) provide one of skill with a general dictionary of many of the terms used in this invention. Any methods and materials similar or equivalent to those described herein can be used in the practice or testing of the present teachings.

Numeric ranges provided herein are inclusive of the numbers defining the range.

### DEFINITIONS

As used herein, the term “granule” refers to a particle which contains a core, an active agent, and at least one coating layer.

As used herein, the term “core” refers to the inner nucleus of a granule. The cores of the present teachings may be produced by a variety of fabrication techniques including: rotary atomization, wet granulation, dry granulation, spray drying, disc granulation, extrusion, pan coating, spheronization, drum granulation, fluid-bed agglomeration, high-shear granulation, fluid-bed spray coating, crystallization, precipitation, emulsion gelation, spinning disc atomization and other casting approaches, and prill processes. Such processes are known in the art and are described in U.S. Pat. No. 4,689,297 and U.S. Pat. No. 5,324,649 (fluid bed processing); EP656058B1 and U.S. Pat. No. 45,4332 (extrusion process); U.S. Pat. No. 6,248,706 (granulation, high-shear); and EP804532B1 and U.S. Pat. No. 6,534,466 (combination processes utilizing a fluid bed core and mixer coating). The clay granule of the present teachings comprises a core upon which a clay layer is built.

The core includes the active agent, which may or may not be coated around a seed. Suitable cores for use in the present teachings are preferably a hydratable or porous material (i.e., a material which is dispersible or soluble in water) that is a feed grade material. The core material can either disperse in water (disintegrate when hydrated) or solubilize in water by going into a true aqueous solution. Clays (for example, the phyllosilicates bentonite, kaolin, montmorillonite, hectorite, saponite, beidellite, attapulgite, and stevensite), silicates, such as sand (sodium silicate), nonpareils and agglomerated potato starch or flour, or other starch granule sources such as wheat and corn cobs are considered dispersible. (Nonpareils are spherical particles made of a seed crystal that has been built onto and rounded into a spherical shape by binding layers of powder and solute to the seed crystal in a rotating spherical container. Nonpareils are typically made from a combination of a sugar such as sucrose, and a powder such as cornstarch.) In one embodiment of the present teachings the core comprises a sodium chloride or sodium sulfate crystal, also referred to as a seed, or other inorganic salt crystal. In another embodiment of the present teachings, the core comprises a sucrose crystal seed. Particles composed of inorganic salts and/or sugars and/or small organic molecules may be used as the cores of the present teachings. Suitable water soluble ingredients for incorporation into cores include: inorganic salts such as sodium chloride, ammonium sulfate, sodium sulfate, magnesium sulfate, zinc sulfate; or urea, citric acid, sugars such as sucrose, lactose and the like. Cores of the present teachings may further comprise one or more of the following: additional active agents, feed or food grade polymers, fillers, plasticizers, fibrous materials, extenders and other compounds known to be used in cores. Suitable polymers include polyvinyl alcohol (PVA), including partially and fully hydrolyzed PVA, polyethylene glycol, polyethylene oxide, polyvinyl pyrrolidine, and carbohydrate polymers (such as starch, amylose, amylopectin, alpha and beta-glucans, pectin, glycogen), including mixtures and derivatives thereof. Suitable fillers useful in the cores include inert materials used to add bulk and reduce cost, or used for the purpose of adjusting the intended enzyme activity in the finished granule. Examples of such fillers include, but are not limited to, water soluble agents such as salts, sugars and water dispersible agents such as clays, talc, silicates, cellulose and starches, and cellulose and starch derivatives. Suitable plasticizers useful in the cores of the present teachings are low molecular weight organic compounds and are highly specific to the polymer being plasticized. Examples include, but are not limited to, sugars (such as, glucose, fructose and sucrose), sugar alcohols (such as, sorbitol, xylitol and maltitol and other glycols), polar low molecular weight organic compounds, such as urea, or other known plasticizers such as water or feed grade plasticizers. Suitable fibrous materials useful in the cores of the present teachings include, but are not limited to: cellulose, and cellulose derivatives such as HPMC (hydroxy-propyl-methyl cellulose), CMC (carboxy-methyl cellulose), HEC (hydroxy-ethyl cellulose). In another embodiment particularly suitable for household cleaning applications, the core comprises a water-soluble or dispersible sugar or salt crystal or a non pareil. Those skilled in the art will recognize that, for feed and food applications, the cores (and any polymers, fillers, plasticizers, fibrous materials, and extenders), are acceptable for food and/or feed applications. For household cleaning applications, such a restriction need not apply.

The term “clay layer” as used herein refers to a layer comprising any of a variety of clay materials containing mostly montmorillonite, including bentonite (both sodium and calcium), phyllosilicates bentonite, kaolin, hectorite, saponite, beidellite, attapulgite, and stevensite. In some embodiments, the clay layer of the present teachings comprises sodium bentonite, and can be referred to as a “bentonite layer”. The clay layer of the present teachings can be added via a fluid-bed spray coating process, or can be added to cores via other routine processes in the art, including rotary atomization, wet granulation, dry granulation, spray drying, disc granulation, extrusion, pan coating, spheronization, drum granulation, fluid-bed agglomeration, high-shear granulation, crystallization, precipitation, emulsion gelation, spinning disc atomization and other casting approaches, and prill processes

As used herein, the term “active agent” may be any material that is to be added to a granule to provide the intended functionality for a given use. The active agent may be a biologically viable material, a food or feed ingredient, an antimicrobial agent, an antibiotic replacement agent, a prebiotic, a probiotic, an agrochemical ingredient, such as a pesticide, fertilizer or herbicide; a pharmaceutical ingredient or a household care active ingredient, or combinations thereof. In a preferred embodiment, the active ingredient is a protein, enzyme, peptide, polypeptide, amino acid, carbohydrate, lipid or oil, vitamin, co-vitamin, hormone, or combinations thereof. In another embodiment, the active ingredient is an enzyme or other biologically active ingredient. Inherently thermostable active agents are encompassed by the present teachings and can exhibit enhanced thermostability in the granules. Any enzyme may be used, and a nonlimiting list of enzymes include phytases, xylanases, β-glucanases, phosphatases, proteases, amylases (alpha or beta or glucoamylases) cellulases, lipases, cutinases, oxidases, transferases, reductases, hemicellulases, mannanases, esterases, isomerases, pectinases, lactases, peroxidases, laccases, other redox enzymes and mixtures thereof. Particularly preferred enzymes include a xylanase from Trichoderma reesei and a variant xylanase from Trichoderma reesei, both available from DuPont Industrial Biosciences or the inherently thermostable xylanase described in EP1222256B1, as well as other xylanases from Aspergillus niger, Aspergillus kawachii, Aspergillus tubigensis, Bacillus circulans, Bacillus pumilus, Bacillus subtilis, Neocallimastix patriciarum, Penicillium species, Streptomyces lividans, Streptomyces thermoviolaceus, Thermomonospora fusca, Trichoderma harzianum, Trichoderma reesei, Trichoderma viride. Additional enzymes include phytases, such as for example Finase L®, a phytase from Aspergillus sp., available from AB Enzymes, Darmstadt, Germany; Phyzyme™ XP, a phytase from E. Coli, available from DuPont Nutrition and Health, and other phytases from, for example, the following organisms: Trichoderma, Penicillium, Fusarium, Buttiauxella, Citrobacter, Enterobacter, Penicillium, Humicola, Bacillus, and Peniophora, as well as those phytases described in U.S. patent applications 61/595,923 and 61/595,941, both filed Feb. 12, 2012. An example of a cellullase is Multifect® BGL, a cellulase (beta glucanase), available from DuPont Industrial Biosciences and other cellulases from species such as Aspergillus, Trichoderma, Penicillium, Humicola, Bacillus, Cellulomonas, Penicillium, Thermomonospore, Clostridium, and Hypocrea. The cellulases and endoglucanases described in US20060193897A1 also may be used. Commercially available cellulases that find use in the present include, but are not limited to CELLUZYME®, CAREZYME® (Novozymes), and KAC-500(B)™ (Kao Corporation). Amylases may be, for example, from species such as Aspergillus, Trichoderma, Penicillium, Bacillus, for instance, B. subtilis, B. stearothermophilus, B. lentus, B. licheniformis, B. coagulans, and B. amyloliquefaciens. Suitable fungal amylases are derived from Aspergillus, such as A. oryzae and A. niger. Commercially available amylases that find use in the present invention include, but are not limited to DURAMYL®, TERMAMYL®, FUNGAMYL®, STAINZYME®, STAINZYME PLUS®, STAINZYME ULTRA®, and BAN™ (Novozymes), as well as POWERASE™ RAPIDASE® and MAXAMYL® P (Genencor). Proteases may be from Bacillus amyloliquefaciens, Bacillus lentus, Bacillus subtilis, Bacillus licheniformis, and Aspergillus and Trichoderma species. Phytases, xylanases, phosphatases, proteases, amylases, esterases, redox enzymes, lipases, transferases, cellulases, and β-glucanases are enzymes frequently used for inclusion in animal feed. Suitable proteases include those of animal, vegetable or microbial origin. In some embodiments, microbial proteases are used. In some embodiments, chemically or genetically modified mutants are included. In some embodiments, the protease is a serine protease, preferably an alkaline microbial protease or a trypsin-like protease. Examples of alkaline proteases include subtilisins, especially those derived from Bacillus (e.g., subtilisin, lentus, amyloliquefaciens, subtilisin Carlsberg, subtilisin 309, subtilisin 147 and subtilisin 168). Additional examples include those mutant proteases described in U.S. Pat. Nos. RE 34,606, 5,955,340, 5,700,676, 6,312,936, and 6,482,628, all of which are incorporated herein by reference. Additional protease examples include, but are not limited to trypsin (e.g., of porcine or bovine origin), and the Fusarium protease described in WO 89/06270. In some embodiments, commercially available protease enzymes that find use in the present invention include, but are not limited to MAXATASE®, MAXACAL™, MAXAPEM™, OPTICLEAN®, OPTIMASE®, PROPERASE®, PURAFECT®, PURAFECT® OXP, PURAMAX™, EXCELLASE™, and PURAFAST™ (Genencor); ALCALASE®, SAVINASE®, PRIMASE®, DURAZYM™, POLARZYME®, OVOZYME®, KANNASE®, LIQUANASE®, NEUTRASE®, RELASE® and ESPERASE® (Novozymes); BLAP™ and BLAP™ variants (Henkel Kommanditgesellschaft auf Aktien, Duesseldorf, Germany), and KAP (B. alkalophilus subtilisin; Kao Corp., Tokyo, Japan). Various proteases are described in WO95/23221, WO 92/21760, WO 09/149200, WO 09/149144, WO 09/149145, WO 11/072099, WO 10/056640, WO 10/056653, WO 11/140364, WO 12/151534, U.S. Pat. Publ. No. 2008/0090747, and U.S. Pat. Nos. 5,801,039, 5,340,735, 5,500,364, 5,855,625, U.S. RE 34,606, U.S. Pat. Nos. 5,955,340, 5,700,676, 6,312,936, and 6,482,628, and various other patents. In some further embodiments, metalloproteases find use in the present invention, including but not limited to the neutral metalloprotease described in WO 07/044993.

Enzymes suitable for inclusion into detergents for household care applications are similar, particularly proteases, amylases, lipases, hemicellulases, redox enzymes, peroxidases, mannanases, pectinases, polyesterases, transferases, and cellulases. In some aspects of the present teachings, the enzymes are selected from phytases, xylanases, beta glucanases, amylases, proteases, lipases, esterases, and mixtures thereof. In one embodiment of the present invention, two enzymes are provided in the granule, a xylanase and a beta-glucanase. The enzymes may be mixed together or applied to the granule separately. In another embodiment, three enzymes are provided in the granule, namely beta-glucanase, xylanase and phytase. In some embodiments, the granule can be in a composition with other granules, builders, surfactants, and other materials. The above enzyme lists are examples only and are not meant to be exclusive. Any enzyme may be used in the clay granules of the present invention, including wild type, recombinant and variant enzymes of bacterial, fungal, yeast, plant, insect and animal sources, and acid, neutral or alkaline enzymes. It will be recognized by those skilled in the art that the amount of enzyme used will depend, at least in part, upon the type and property of the selected enzyme and the intended use.

As used herein, the term “bleach detergent base” refers to a base containing sufficient bleach such that storage at 8 weeks at 32C and 80% relative humidity results in a decrease in the activity of an active agent enzyme therein by at least 5%, when the enzyme is found in a granule B1 according the present teachings, with the 30% bentonite being replaced with 30% sodium sulfate. An illustrative bleach detergent base can comprises 30% sodium citrate dehydrate, 6% maleic acid/acrylic acid copolymer sodium salt, 5% sodium perborate monohydrate, 2% TAED, 25% sodium silicate (noncrystalline), 2% linear fatty alcohol ethoxylate, and the balance enzyme granule and anhydrous sodium carbonate.

As used herein, the term “enzyme matrix” refers to recovered enzyme arising from a fermentation, and additional components as processing aids including for example binders (e.g. PVA), anti-foam agents, surfactants (e.g. lutensol), starch, and sugar.

As used herein, the term “lack detectable spotting and filming” refers to the assessment of spots by a trained human using a General Electric washing machine, 50C normal cycle with water hardness of 9GH, using wine glasses and dishes made of glass. A scale of 1 (no spots), 2 (spots at random), 3 (about ¼ of the surface covered), 4 (about ½ of the surface covered), and 5 (virtually completely covered) is used. Using this test, and finding a consistent value of 1, results in a finding of dishes that “lack detectable spotting and filming”.

The term “coating layer” and “layer” as used herein are interchangeable. The first coating layer generally encapsulates the core in order to form a substantially continuous layer so that the core surface has few or no uncoated areas. Subsequent coating layers can encapsulate the growing granule to form one or more additional substantially continuous layer(s). Accordingly, as used herein, an “additional layer” refers to one or more coatings applied to a granule, and can contain any of a variety of materials readily available to one of routine skill in the art, including those materials described under “cores”, as well as may be found in the relevant arts, including U.S. Pat. No. 7,018,821, U.S. Pat. No. 8,076,113, U.S. Pat. No. 4,106,991, U.S. Pat. No. 4,689,297, and U.S. Pat. No. 4,740,469.

### Exemplary Embodiments

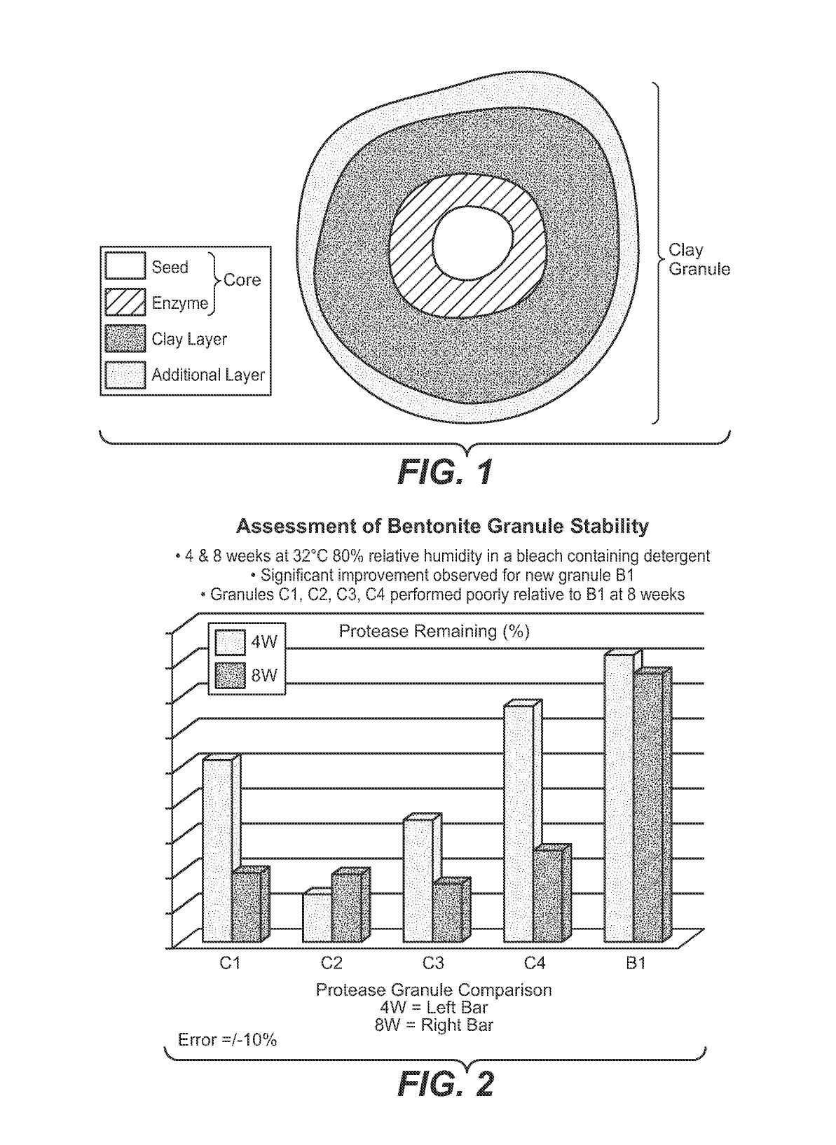

In an embodiment illustrative of the invention according to FIG. 1, a granule comprises a seed (such as a salt crystal, for example a sodium sulfate crystal), around which an active agent such as an enzyme is coated. The resulting core can then be subjected to a fluid-bed spray coating process for addition of the various layers to make a clay granule. As depicted here, a first enzyme layer is present surrounding a seed (collectively forming a “core”), followed by a bentonite layer, which in turn is followed by an additional layer.

In some embodiments, the seed and enzyme are made using fluid-bed spray coating, such that the enzyme is deposited as a coating onto a seed, to make a core. In some embodiments, the seed and enzyme are made through other means, such that the enzyme does not comprise a layer over the seed but can rather be interspersed with any of a variety of material(s).

In some embodiments, the clay layer is directly adjacent to the core, such that there are no intervening layers. In some embodiments, there can be one or more intervening layers between the core and the clay layer. In some embodiments, there are more than one additional layers located external to the clay layer.

In one embodiment, the entire granule is made using fluid-bed spray coating, wherein a seed is first coated with an enzyme layer, the enzyme layer is next coated with a bentonite layer, and then an additional layer is added. In such a granule, no intervening layers between the layers are implemented.

In some embodiments, the granules of the present teachings comprise an active agent that retains at least 60, 65, 70, 75, 80, 85, 90, 95%, 99%, or 100% activity after a storage process conducted in a bleach detergent base for 8 weeks of storage at 32C and 80% relative humidity.

In some embodiments, the granule of the present teachings comprises an inorganic salt seed (for example sodium sulfate), an active agent including SEQ ID NO: 1, or a protein 70%, 75%, 80%, 85%, 90%, 95%, or 99% identical to it, a clay layer comprising bentonite (for example 25-35%, 28-33%, 29-31%, or 30% w/w), and an additional layer.

The invention can be further understood by reference to the following examples, which is provided by way of illustration and not meant to be limiting.

### Examples

Performance testing was conducted with a granule (hereafter “B1”) containing a bentonite layer made by fluid-bed spray coating using a Bacillus subtilis protease (SEQ ID NO: 1).

SEQ ID NO: 1
aqsvpwgisrvqapaahnrgltgsgykvavldtgisthpdlnirgg
asfvpgepstqdgnghgthvagtiaaldnsigvlgvapraelyavk
vlgasgsgsvssiaqglewagnnrmhvanlslglqapsatleqavn
satsrgvlvvaasgnsgagsisyparyanamavgatdqnnnrasfs
qygagldivapgvnvqstypgstyaslngtsmatphvagaaalvkq
knpswsnvqirnhlkntatslgstnlygsglvnaeaatr

Using conventional fluid-bed spray coating, this B1 granule was made according to the following ingredients.

TABLE 1

| Function | Ingredient for fluid bed process |
|---|---|
| Active Agent | Protease Blend Concentrate; 76.26 mg |
| | protease/g solution, 18.99% dry solids, |
| | 1.061 density, 5.26 pH (26.4% enzyme |
| | solids w/w of granule) |
| Granule Seed | Sodium Sulfate ~300 um (30.58% w/w) |
| Enzyme Matrix | PVA (1% w/w) & antifoam (.5% w/w) |
| Bentonite Layer | 30% w/w Bentonite, Accofloc 350 BLK, |
| | from American Coloid, 19f grade. |
| Additional layer | TiO2 (5.5% w/w), PVA (4.5% w/w) & |
| External to the | Lutensol (1.5%) |
| Bentonite layer | |

This B1 granule showed no loss in performance after 8 weeks of storage at 32C and 80% relative humidity in a bleach detergent base. Biochemical analysis of this granule, compared to similar granules in which the bentonite layer was replaced with sodium sulfate, showed that oxidation of a methionine residue at position 222 was minimal in the bentonite layered granule B1. Further, a Heubach dust test showed that the B1 granules showed no increase in dusting relative to control granules. The mean diameter of the B1 granules was determined to be 566.2 microns.

A comparison to various control granules is shown in FIG. 2. The bentonite granule B1 showed superior stability performance to granule C4 (a granule similar in structure to B1 but substituting 20% sodium sulfate for the 30% bentonite, and containing an extra PVA/talc layer external to the enzyme layer), granule C3 (50% larger outer additional coating than B1, and having 20% sodium sulfate instead of the bentonite layer), granule C2 (20% bentonite layer, otherwise identical to B1), and C1 (similar to C4 but with 11.5% sodium sulfate, but more TiO2 and PVA in the outer coating).

Additional experiments confirmed that granule B1 performed better in a stain removal assay following the 8 weeks of storage at 32C and 80% relative humidity.

1. A granule comprising
a core with an active agent enzyme matrix, wherein the active agent enzyme matrix comprises SEQ ID NO: 1 or a protein 80%, 90%, 95%, or 99% identical to SEQ ID NO:1; and,
a clay layer comprising no less than 25% clay.

2. The granule according to claim 1 wherein the core comprises a crystal of sodium sulfate.

3. The granule according to claim 1, wherein the enzyme matrix comprises PVA and anti-foam.

4. The granule according to claim 1, wherein the clay comprises bentonite, and the bentonite comprises 25-35%, 28-33%, 29-31%, or 30% w/w of the overall granule.

5. The granule according to claim 1, wherein an outer additional coating comprises PVA, TiO2, and lutensol.

6. The granule according to claim 1, wherein the enzyme matrix comprises at least one of talc, sucrose, and starch.

7. Method of washing dishes in an automated dish washer comprising mixing a bleach detergent base comprising the granule of claim 1; and, washing said dishes.

8. A method of washing dishes with a bleach detergent base comprising the granule of claim 1, wherein the resulting dishes lack detectable spotting and filming, wherein the granules comprise 0.5-1.5%, or 1%, w/w of the bleach detergent base.

9. A bleach detergent base comprising the granules of claim 1.

10. A method of making a clay granule in fluid-bed spray coater comprising;
providing a seed;
spraying a first layer onto the seed with the fluid-bed spray coater, wherein the first layer comprises an active agent, to form a core; and,
spraying a second layer onto the core with the fluid bed spray coater, wherein the second layer comprises 25%-35% bentonite.

11. The use of the granule according to claim 1 in an automatic dish washing application.


SEQUENCE LISTING (1 sequence)

SEQ ID NO: 1 - protein, 269 aa, Bacillus subtilis
  misc_feature: Bacillus subtilis protease
AQSVPWGISRVQAPAAHNRGLTGSGVKVAVLDTGISTHPDLNIRGGASFVPGEPSTQDGNGHGTHVAGTIAALDNSIGVLGVAPRAELYAVKVLGASGSGSVSSIAQGLEWAGNNRMHVANLSLGLQAPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR